(19) United States
(12) Patent Application Publication
(10) Pub. No.: US 2025/0099794 A1
(43) Pub. Date: Mar. 27, 2025

(54) FIRE EXTINGUISHING DEVICE

(71) Applicant: YOGESH KANTILAL DOSHI, VADODARA (IN)

(72) Inventor: FALGUN KANTILAL DOSHI, VADODARA (IN)

(73) Assignee: YOGESH KANTILAL DOSHI, VADODARA (IN)

(21) Appl. No.: 18/264,931

(22) PCT Filed: Jul. 28, 2022
(86) PCT No.: PCT/IN2022/050680

§ 371 Date: Aug. 10, 2023

(30) Foreign Application Priority Data
Jun. 15, 2022 (IN) 202221034254

(51) Int. Cl. A62C 35/06

(52) U.S. Cl. CPC A62C 35/06

(57) ABSTRACT

The present invention relates to fire safety devices, and particularly to a fire extinguishing device that can be safely deployed into difficult to reach areas. In particular, this invention relates to a device that disperses fire fighting Dry chemical powder composition through the use of an impact force. When a fire breaks out, simply throw the device towards the fire. It will impact naturally in contact with any surface and will activate/blast in instant and the fire is extinguished. No pin or spare parts or training is required.

### FIELD OF THE INVENTION

The present invention relates to fire safety devices, and particularly to a fire extinguishing device that can be safely deployed into difficult to reach areas. In particular, this invention relates to a device that disperses fire-fighting Dry chemical powder composition through the use of an impact force.

### BACKGROUND OF THE INVENTION

Fire-fighting devices in general use at present, are subject to numerous limiting factors with respect to their cost of acquisition, placement, storage, deployment for fire-fighting or fire suppression and other factors. By their nature, they may require periodic inspection by qualified, knowledgeable persons, training or esoterically detailed familiarity in their use. These are typically bulky and/or require, as centralized sensing and extinguishing systems, extensive, expensive installation to afford the protection they are designed to provide.

Small fire safety devices, such as the common pressurized dry chemical powder extinguisher, are relatively heavy, due to the prerequisite construction of their pressurized containers. Their weight, bulk and relative complexity, adds to the cost of manufacture, and therefore, theoretically, their cost of acquisition. In use, their directed stream of chemical spray requires judgment and forethought, and therefore, a fully conscious and cognizant user whose mental faculties have not been impaired by smoke, heat, mental stress or panic.

Sprinkler systems, are subject to high installation costs, and may fail to effectively fight fires due to limited water supplies, pump failures, sedimentary clogging of water supply in piping, or failure to install sprinkler heads with sufficient coverage areas throughout an edifice, among other factors.

A drawback to nearly any fixed installation of fire-fighting equipment, such as fire hoses and sprinklers, is that they are often installed with less than complete coverage area for the full extent of the interior space they were installed to protect, due to installations, the limits of their dispersal patterns from fixed mountings, or physical obstructions to retardant discharge. An example being a single dispersal unit, such as a water sprinkler head, in the center of a hotel room, which if actuated due to fire, would have a dispersal pattern which might not reach all corners of an irregularly shaped room, such irregularities commonly including short entrance corridors and closets blinded from the sprinkler head by corners, etc.

When one is faced with a fire emergency, one of the most difficult and dangerous aspects of combating the fire is being able to approach close enough to effectively extinguish the flames with whatever means are available. In most situations, it may be relatively safe to hose down a burning building or domicile with water or fire extinguishing chemicals from a distance. However, firefighters sometimes must charge into the burning building in their attempts to rescue survivors. In this scenario, firefighters face many hazards, such as smoke, back drafts and potential falling debris. Even if a survivor is reached, rescue may not be possible due to surrounding fire. The surrounding fire may be located in a place where the conventional fire hose cannot reach or so vigorous that a conventional fire extinguisher will be ill suited to handle the flames.

Thus, the present invention is designed as a product which is versatile in installation mounting, i.e., mountable in a simple holder on walls, desk, counter or table surfaces, or elsewhere, and be able to use when situated as thus, can be lifted out of its holder and thrown at the target, should any occupant of the room or area deem appropriate, and be conscious and capable of doing so.

Explosive devices for fire-fighting purposes, in prior, have often demonstrated high efficiency in extinguishing localized blazes, but have shown limitations, again, in cost and the relative sophistication of their design impacting complexity in manufacturing process. Also their methods of storage, deployment and/or use, such designs may require expert use, inhibiting broad public acceptance. Again, as mentioned previously, dispersal patterns of the fire extinguishing chemicals from some explosive fire-fighting devices may, in some cases, be less than uniform or ideal.

Two other important detractions to explosively dispersed chemical fire-fighting devices are the force of detonation experienced with some, and subsequent flying debris from even some minute parts of such devices, despite frangible casings, therefore being therein safety hazards unto themselves.

In nearly all prior, be they of explosive type or other means of delivery, the cost of manufacture and/or installation, and therefore the cost of purchase is a limiting factor to broad public demand; this factor being most acutely apparent in underdeveloped countries, and even in lesser privileged communities of developed nations.

Frequently, only one fire-extinguisher is maintained for the entirety of a private dwelling, and it may fail to work after lying dormant many years, due to its need of periodic inspection and maintenance by qualified personnel; something often overlooked by owners of private dwellings. And with only one fire-fighting device deployed at some point within the dwelling, the possibility exists that a path to it may be blocked by flame and/or smoke, especially when a fire starts and spreads while the occupants are asleep.

To overcome the limitation of the existing problems in the present invention system is use.

### OBJECT OF THE INVENTION

The main objects of the present invention device are as follow:
The present invention device is very light weight so, it can be easily carried by any age of person
To operate the present invention device, there is no requirement of any operational skill, any age person can easily use the present invention device.
The present invention device is very effective to blow out fire with immediate effect.
The present invention device is very cost effective.
Further, the present invention device is not required to operate by going closer to fire, user can toss it from a distance and the device will burst due to impact force, the content of the device will extinguish the fire.
The present invention device and the Dry chemical powder composition which filled into the device is Human & Environmentally Friendly-Not toxic for humans and the environment.
There is no special training or skill is required to operate such fire Device.
Further the device has zero maintenance cost, it does not require any inspection or maintenance cost for the life period of 5 Years.
The present device is easy to handle, where the fire extinguishing device is lightweight, weighing from 200 gm to 5 kg.
The present device is available in different sizes from 2″ to 12″ which is easily kept anywhere, even in pam for women, children and the elderly. Anyone can react and use it fast!
When a fire breaks out, simply throw the device towards the fire. It will impact naturally in contact with any surface and will activate/blast instant and extinguish the fire. No pin or spare parts or training is required.
The present device is ambient temperature resistant. It will not blast up to 65 degree centigrade temperature

### STATEMENT OF THE INVENTION

For a better understanding of the invention, its operating advantages and the specific objects attained by its uses, reference should be taken from the accompanying drawings and description in which these are illustrated the preferred embodiments of the invention.

When a fire breaks out, simply throw the device towards the fire. It will impact naturally in contact with any surface and will activate/blast in instant and the fire is extinguished. No pin or spare parts or training is required.

### BRIEF DESCRIPTION OF THE DRAWINGS

The structure and the technical means adopted by the present invention is to achieve the above and other objects can be best understood by referring to the following detailed description of the preferred embodiments and the accompanying drawings.

FIG. 1 represents the different sizes line 2″/12″ of the present invention device which is easily kept even in pam and also the different capacity like 200 gm to 5 kg of the present invention device.

FIG. 2 represents the different shape of the present invention device which may be in the ANY Shape.

FIG. 3 represents the different types of mounting style like Wall mounting, Ceiling/Hanging mounting, Desk mounting, etc.

FIG. 4 represents the different types of Triggers i.e., Ball bullets gun, Fire ball blaster gun, also device carry by Drone to give any person who is trapped in fire to extinguishing the fire and also Drone can trigger the device to extinguish the fire.

FIG. 5 represents the different Colors and Designs:-Attractive fluorescent color like green, blue, pink, yellow, red, etc. of the present invented device

### DETAILED DESCRIPTION OF THE INVENTION

Before explaining the present invention in detail, it is to be understood that the invention is not limited in its application to the details of the construction and arrangement of parts illustrated in the accompanying drawings. The invention is capable of other embodiments, as depicted in different figures as described above and of being practiced or carried out in a variety of ways. It is to be understood that the phraseology and terminology employed herein is for the purpose of description and not of limitation.

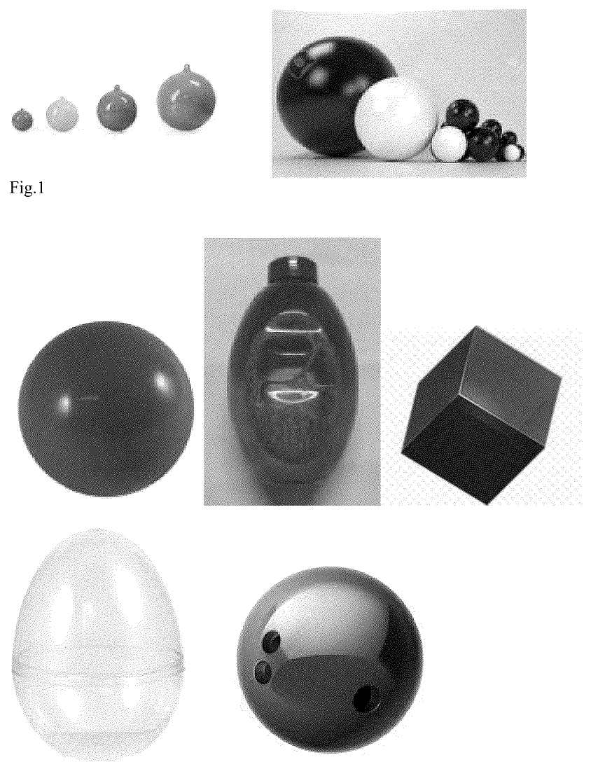

As shown in FIG. 1 the present invention device is available in different size of the device, the size of the device can be 2 inch to 12 inch as per the requirements and also in different capacity of the devise, the capacity of the device can be 200 gm to 5 kg as per requirements, it can be easily kept into the hand for throwing toward the fire to blow out.

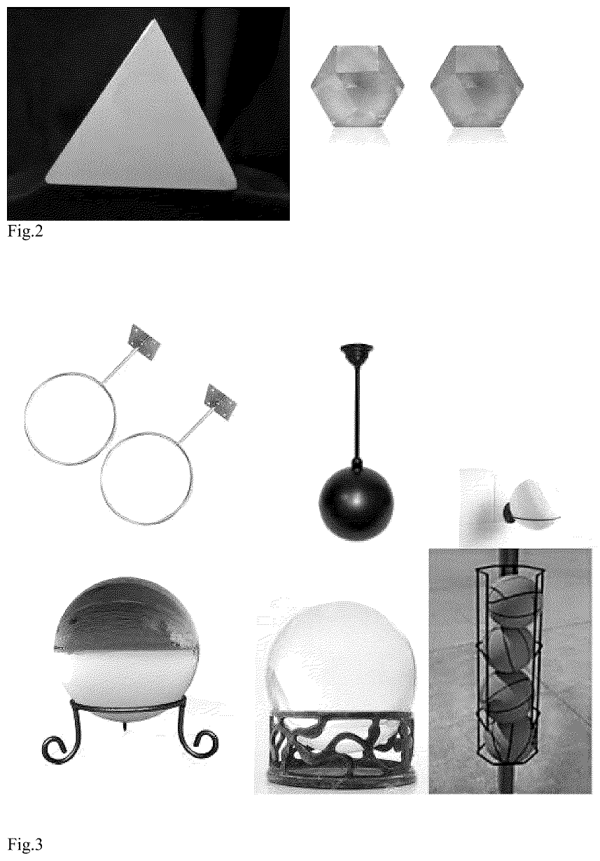

In the FIG. 2 different shape of the present invention device is available wherein shape may be as per the choice, which can be easily mounted on wall mounting or ceiling/hanging mounting, desk mounting or table top product as shown in FIG. 3.

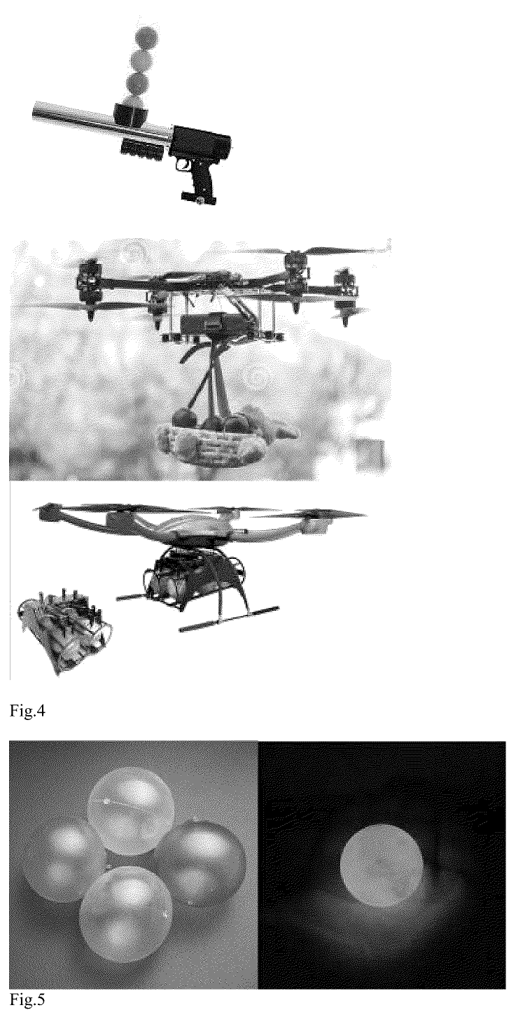

The present invention device can be trigger with gun for continues triggering to blow out fire with handy device and also device carry by Drone to give any person who is trapped in fire to extinguishing the fire and also Drone can trigger the device to extinguish the fire as shown in FIG. 4. Moreover the present invention device is available in different attractive fluorescent colors so it can be easily highlighted while keeping as different mounting method i.e., wall mounted or ceiling/hanging type or table top mounted which is shown in FIG. 5

In the present invention fire device is filled with DCP Powder Extinguishing media which can be Pressurized from 1 kg/cm2 to 12 kg/cm2 as per requirement.

The main object of the present invention device is that it will not bounce back from any surface while throwing toward the fire, it will easily crush at the surface point where it comes into the contact with impact force and the Dry chemical powder composition will come into the contact of fire place and will activate immediately so, it will start blow out fire immediately.

While, the invention has been described with respect to the given embodiment, it will be appreciated that many variations, modifications and other applications of the invention may be made. However, it is to be expressly understood that such modifications and adaptations are within the scope of the present invention, as set forth in the following claims.

We claim:

1. Fire Extinguishing Device comprising with different size, shape, capacity, color and mounting arrangements
Wherein the device size can be very from 2 inch to 12 inch;
Wherein the device capacity can be very from 200 gm to 5 kg;
Wherein the device is available in different ANY shape;
Wherein the device can be mounted on wall, ceiling or table top;
Wherein the device is filled with Dry chemical powder composition.

2. Fire Extinguishing Device as claimed in claim 1 wherein Dry Chemical Powder composition contains mixture Pressurized 1 kg/cm2 to 12 kg/cm2.

3. Fire Extinguishing Device as claimed in claim 1 wherein the weight of the device may vary from 200 gm to 5 kg

4. Fire Extinguishing Device as claimed in claim 1 wherein the life of the device is 5 Years.

5. Fire Extinguishing Device as claimed in claim 1 wherein the device sizes vary from 2″ to 12

6. Fire Extinguishing Device as claimed in claim 1 wherein device will not blast up to 65 degree centigrade temperature.

7. Fire Extinguishing Device as claimed in claim 1 wherein device is made from Fire resistance plastic material.
